(19) United States
(12) Patent Application Publication
(10) Pub. No.: US 2007/0219687 A1
(43) Pub. Date: Sep. 20, 2007

(54) DEVICE FOR CONTROLLING AN AUTOMATIC GEARBOX FOR THE POWER-TRAIN OF A MOTOR VEHICLE AN ASSOCIATED METHOD

(75) Inventor: Frederic Roudeau, Vitry Sur Seine (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Renault S.A.S., Boulogne Billancourt (FR)

(21) Appl. No.: 11/572,686

(22) PCT Filed: Jul. 13, 2005
(86) PCT No.: PCT/FR05/50585

§ 371 Date: Mar. 14, 2007

(30) Foreign Application Priority Data
Jul. 27, 2004 (FR) 0408261

(51) Int. Cl. G07F 7/00

(52) U.S. Cl. 701/36

(57) ABSTRACT

A device for controlling an automatic gearbox for the power train of a motor vehicle includes a first computing device for driving heat engine of the motor vehicle power train and a second computing device for driving the heat engine and the motor vehicle automatic gear box, which is connected to the first computing device by a communications network. The control device also includes an interpretation module for generating a torque applied on the vehicle wheels and including a dynamic component, a static component, a second optimization module, and a third translation module. The first computing device for driving the heat engine includes the first interpretation module, the second optimization module, and the second computing module for driving the heat engine and the automatic gearbox includes the third translation unit.

The present invention relates to a device for controlling a gearbox for the power-train of a motor vehicle.

This control device advantageously applies to automatic gearboxs, in particular impulse-control boxes, ICB, automatic gearboxes, AGB, and robotized gearboxes, RGB, but also the continuous-ratio transmissions, such as CVT (Continuous Variable Transmission), IVT (Infinitely Variable Transmission) and hybrid transmissions.

An automatic gearbox for a motor vehicle conventionally comprises a control block receiving one or more input parameters interpreting, among other things, the will of the driver. Then, according to the value of these parameters, the control block delivers a control set-point intended for the wheels of the motor vehicle.

A development of such a control block has already been disclosed in document FR-A-2827339, in the name of the Applicant. This document details a device for controlling the operating point of a power-train. The control provided by this device is a torque-mode control to be applied to the wheels of the motor vehicle. As defined in document FR-A-2827339, the value of the torque to be applied to the wheels of the motor vehicle is calculated directly on the wheels of the motor vehicle.

The device of document FR-A-2827339 has a module for interpreting the will of the driver, called IVC module.

The IVC module generates a torque setpoint to be applied to the wheels, intended for an operating point optimization block OPF. The IVC module generates this torque setpoint according to the will of the driver, the characteristics of the motor vehicle and its environment, in order to best adapt the behavior of the motor vehicle. The OPF block, for producing the coordinates of an operating point of the power-train, transmits for this purpose said torque to provide a torque-mode control to be applied to the wheels of the motor vehicle. Furthermore, the OPF block simultaneously generates an engine speed setpoint created from said torque to be applied to the wheels of the motor vehicle.

A third COS (System Control) module translates the coordinates of the operating point into control signals adapted to the power-train.

Implicitly, the control device disclosed in document FR-A-2827339 is incorporated in a single computer or computation means. However, a conventional hardware architecture has two separate computers or computation means, one dedicated to calculating heat engine controls and parameters, the other to calculating transmission controls and parameters.

Such an architecture requires, on the one hand, an appropriate distribution of the tasks performed by the various modules mentioned above, and, on the other hand, securing of the information interchanges between the various modules.

These adaptations make it possible to control the torque to be applied to the wheel without risk to the driver and the passengers of the motor vehicle. They also allow for a standardization of the manual and automatic gearbox controls, for motor vehicles of one and the same range, for example, where only the calibrations will differ.

The object of the present invention is to remedy the abovementioned drawbacks. The principle of the invention provides for the distribution of the various modules of the control device according to the role of each relative to the heat engine and to the automatic gearbox, and the parameters involved.

To this end, the invention proposes a device for controlling an automatic gearbox for the power-train of a motor vehicle comprising a first computation means for driving a heat engine of the power-train of the motor vehicle and a second computation means for driving the heat engine and the automatic gearbox of the motor vehicle and linked to the first computation means by a communication network. The control device further comprises:
a first (interpretation) module for generating a torque to be applied to the wheels of the motor vehicle comprising a dynamic component and a static component, and interpreting the will of the driver according to input data representative of the characteristics of the motor vehicle, the will of the driver and the environment of the motor vehicle,
a second (optimization) module for optimizing an operating point of the power-train as a function of the torque setpoint to be applied to the wheel delivered by said first module, and
a third (translation) module for translating the coordinates of the operating point into control signals adapted to the power-train.

The first computation means for driving the heat engine mainly comprises the first (interpretation) module and the second (optimization) module. The second computation means for driving the heat engine and the automatic gearbox mainly comprises the third (translation) module.

The distribution of the various modules according to the two computation means respectively dedicated to the power-train and to the gearbox of the motor vehicle makes it possible to simultaneously parameterize the values used jointly by the modules included in one and the same computation means.

According to one embodiment, the communication network comprises means for setting up a specific data interchange protocol, verifying that the data received by one computer is actually the latest data updated by the other computer.

According to another embodiment, the first computation means further comprises a software program dedicated to driving the heat engine of the automatic vehicle, for determining the actions to be applied to said heat engine.

According to one embodiment, the automatic gearbox advantageously comprises units and at least one electric motor associated with at least one electrical energy storage element. The electrical machines are likely to operate at least part of their operating time as traction engine for the motor vehicle. The use of a hybrid power-train therefore makes it possible to reduce the energy consumption of the motor vehicle, given that at least one electric motor can operate in electrical energy recovery mode.

The second computation means further comprises a software program dedicated to driving the automatic gearbox of the motor vehicle, for determining the actions to be applied to said units of the automatic gearbox.

According to one embodiment, the second optimization module is fed with the following input parameters:
the dynamic component of the torque setpoint to be applied to the wheels of the motor vehicle,
the static component of the torque setpoint applicable to the wheels of the motor vehicle,
a positive limiting Setpoint of the speed gradient intended for the heat engine,
a negative limiting setpoint of the speed gradient intended for the heat engine,
   the input parameters being generated by means contained in the first (interpretation) module.

According to one embodiment, the second (optimization) module comprises means for generating a speed setpoint for the heat engine, for correcting the dynamic component of the torque setpoint to be applied to the wheels of the motor vehicle and generating a new dynamic component of the torque setpoint to be applied to the wheels of the motor vehicle.

According to one embodiment, the communication network comprises means for transferring the speed setpoint for the heat engine and the dynamic component of the torque setpoint to be applied to the wheel of the motor vehicle, from the second (optimization) module to the third (translation) module.

According to one embodiment, the third module comprises means for generating a new speed setpoint for the heat engine, torque setpoints for the electric motor of the motor vehicle, current, voltage or power setpoints, for the electrical energy storage elements and an engine torque setpoint intended for the heat engine.

According to one embodiment, the communication network comprises means for transferring the engine torque setpoint intended for the heat engine, from the third (translation) module to the software program for driving the heat engine.

According to one embodiment, the automatic gearbox and the heat engine of the motor vehicle are fed by a control setpoint respectively generated by the software programs for driving the automatic gearbox and the heat engine of the motor vehicle.

According to one embodiment, the software programs for driving the automatic gearbox, the heat engine and the electric motor of the motor vehicle can be fed by data obtained respectively from integrated sensors on the automatic gearbox and on the heat engine of the motor vehicle.

According to one embodiment, the first (interpretation) module can be fed by wheel anti-lock and motor vehicle path control setpoints, delivered by an additional computation means.

Another aspect of the invention relates to a method of controlling an automatic gearbox of a power-train for a motor vehicle, generating, in a first computation means, data for driving a heat engine of the power-train of the motor vehicle, and, in a second computation means, data for driving the heat engine and the automatic gearbox of the motor vehicle. In the first computation means, there is generated, by interpreting the will of the driver, a torque setpoint to be applied to the wheels of the motor vehicle and an operating point determined as a function of said torque to be applied to the wheels of the motor vehicle is optimized. In the second computation means, the coordinates of the operating point are translated into control signals adapted to the power-train.

According to one embodiment, data is interchanged between the first and the second computation means via a secure communication network.

Other advantages and characteristics of the invention will become apparent from examining the detailed description of embodiments of the invention, by no means limiting, and the appended drawings, in which;

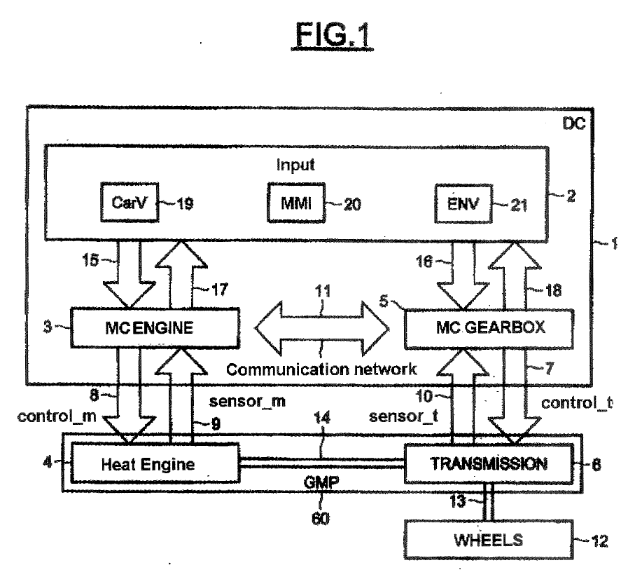

FIG. 1 is a block diagram of an exemplary embodiment of an automatic gearbox control device,

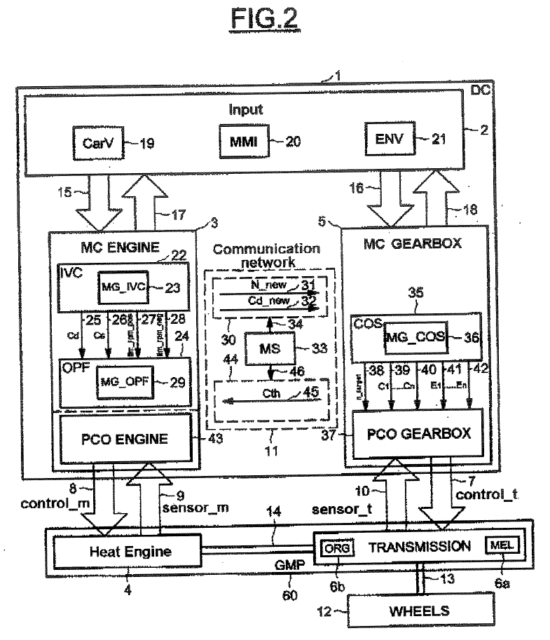

FIG. 2 more specifically represents the control device of an automatic gearbox represented in FIG. 1,

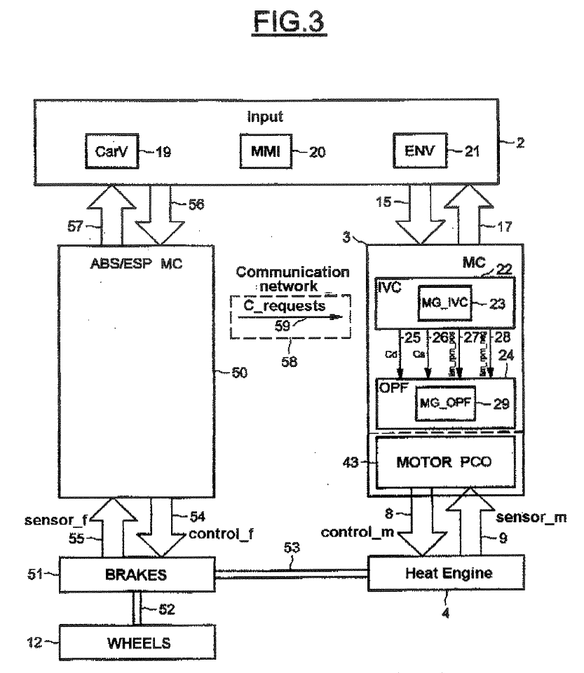

FIG. 3 diagrammatically illustrates a variant of the control device of an automatic gearbox

Referring to FIG. 1, this figure shows the architecture of the control device of an automatic gearbox for a power-train of a motor vehicle.

The control device 1 DC comprises a first input block 2 and two computation means for driving a power-train (60) comprising a heat engine (NTH) 4 and an automatic gearbox 6. The first computation means 3 is for driving the heat engine 4. The second computation means 5 is for generating setpoints for driving the heat engine 4 and the automatic gearbox 6. Control setpoints control_t and control_m are transmitted to the automatic gearbox 6 and to the heat engine 4 respectively by connections 7 and 8. Moreover, the computation means 3 and 5 take account of the information in the signals sensor_m and sensor_t sent by the sensors (not shown) incorporated in the heat engine 4 and the gearbox 6, and transmitted via connections 9 and 10.

A communication network 11 links the two computation means 3 and 5, allowing for a secure data interchange according to a method described in more detail below.

The automatic gearbox 6 controls the wheels 12 of the motor vehicle via control means 13 known to those skilled in the art. The automatic gearbox 6 is also linked to the heat engine 4 by a connection 14.

The function of the input block 2 is to deliver the input parameters to the computation means 3 and 5, respectively via the connections 15 and 16.

Furthermore, the input block 2 receives via the connections 17 and 18 information obtained from detectors (not shown) incorporated in the computation means 3 and 5, in order to record any operating errors.

The input block 2 comprises three modules 19, 20 and 21. Each of these three modules delivers to the computation means 3 and 5 and to the set of functional blocks that they comprise, a type of predetermined input data.

A first module 19, denoted CarV, is capable of generating the data concerning the characteristics of the motor vehicle. This data is programmed and stored in a memory common to the device 1 Dc (not shown). This data is defined by the manufacturer of the motor vehicle to characterize the behavior of the motor vehicle.

The second module 20, denoted MMI (man/machine interface) is capable of generating data concerning the will of the driver. This data interprets the wishes of the driver. It can comprise, for example, signals representative of the brake or accelerator pedal of the motor vehicle or even a signal interpreting the sportiness of the driver.

A third module, denoted 21 ENV, is capable of generating signals concerning the environment of the motor vehicle. The latter can be used to take account of the state of the motor vehicle and its situation in the environment. They comprise, for example, signals corresponding to the speed of the motor vehicle, or even to the acceleration of the motor vehicle.

The signals produced by the three modules 19, 20 and 21 are generated from signals originating from the sensors incorporated in the motor vehicle (not shown).

Reference is now made to FIG. 2. The latter describes in more detail the control device of FIG. 1 by illustrating the distribution in the two computation means 3 and 5 of the various modules for the control of an automatic gearbox, as set out in the document FR-A-2827339, in the name of the Applicant.

The control device comprises a first (interpretation) module 22 IVC (interpreting the will of the driver) incorporated in the engine computation means 3. The module 22 comprises generation means 23 MG_IVC, for generating a torque setpoint to be applied to the wheels of the motor vehicle by interpreting the will of the driver.

This torque setpoint comprises two components, a dynamic component Cd and a static component Cs. The dynamic torque setpoint Cd is the value of the torque that the driver wishes to see produced immediately. The static torque setpoint Cs is defined as the torque that the driver could request and that the power-train should make immediately available to the wheels of the motor vehicle. The setpoint Cs evolves slowly. In practice, its aim is not to respond to an immediate request from the driver. It should be a reflection of a trend imposed by the behavior of the driver for a predetermined period. In other words, the torque Cs corresponds to the torque value that the driver wishes to obtain applied to the wheels of the motor vehicle by operating the accelerator pedal of the motor vehicle.

The generation means 23 can also generate an engine speed variation limitation setpoint. The engine speed variation limitation defines the maximum engine speed variation during a predetermined time interval. The engine speed variation limitation comprises two components:
a component of the engine speed variation limitation signal for limiting the engine speed variations in the reducing direction, lim_rpm_neg,
a component of the engine speed variation limitation signal for limiting the engine speed variations in the increasing direction, lim_rpm_pos.

The module 22 generates this data from input data delivered by the input block 2 and transmits it to a second (optimization) module 24 OPF (operating point optimization). The dynamic Cd and static Cs components are transmitted respectively by the connections 25 and 26 to the optimization module 24. The components of the positive lim_rpm_pos and negative lim_rpm_neg engine speed variation limitation signal are transmitted respectively by the connections 27 and 28 to the module 24.

Given that the module 24 is also located in the engine computation means 3, the number of data interchanges over the communication network 11 is limited.

The module 24 computes the coordinates (engine speed; torque to be applied to the wheel) of the operating point of the power-train 60.

Also, the module 24 has generation means 29 MG_OPF which create, from parameters delivered by the module 22 and the input block 2, a new dynamic torque component Cd_new to be applied to the wheel and an engine speed setpoint N_new.

The modules 22 and 24 of the engine computation means 3 compute so-called high-level data, intended for other blocks of the control device 1 and used to create data for all the power-train 60.

The data Cd_new and N_new is transmitted from the engine computation means 3 to the gearbox computation means 5, via the subnetwork 30 of the communication network 11. The subnetwork 30 handles the transfer of data from the engine computation means 3 to the gearbox computation means 5. It comprises two connections 31 and 32 respectively for transferring the engine speed setpoint N_new and the new dynamic torque component Cd_new to be applied to the wheel.

The transfer of this data is secured by securing means 33 MS for setting up a specific data interchange protocol over the subnetwork 30, via the connection 34. The secure interchange protocol can, for example, be that described in U.S. Pat. No. 5,734,322, filed by NISSAN, which is intended for motor vehicles provided with automatic gearboxes.

The interchange protocol described in the document U.S. Pat. No. 5,734,322 makes it possible to check that the information transmitted between two modules is indeed newly transmitted information and not the copy of previous information. For this, a control signal is transmitted via a transmission circuit between the engine computation means and the gearbox computation means, for example. The transmitted value is compared with the expected value. If a malfunction is detected, that is, if the transmitted value is different from the expected value, the receiving computation means, in this case the gearbox computation means, can activate an appropriate safety mode. This safety mode can, for example, enable the motor vehicle to run at reduced speed, to avoid endangering the occupants of the motor vehicle.

Based on the setpoints N_New and Cd_New, the computation means 5 create so-called low-level data. The low-level data is intended for software programs dedicated to the creation of setpoints for the heat engine 4 and the automatic gearbox 6. The software programs are described in more detail below.

The setpoints Cd_new and N_new are generated for the third (translation) module 35 COS, located in the gearbox computation means 5. The module 35, described in document FR-A-2827339 in the name of the Applicant, makes it possible to translate the coordinates of the operating point created by the module 24 OPF, into signals adapted to the power-train. Based on the setpoints Cd_new and N_new, generation means 36 MG_COS of the module 35 creates a target engine setpoint N_target, torque setpoints C1, . . . , Cn. The torque setpoints C1, . . . , Cn are intended for electric motors 6a MEL, included in the gearbox 6, in the case of a hybrid engine, that is, having both a heat engine and at least one electric motor. The generation means 36 also generate current and/or voltage and/or power setpoints E1, . . . , En, for electrical energy storage means (not shown) associated with the electric motors 6a.

These various parameters N_target, C1, . . . , Cn, E1, . . . , En, are transmitted, permanently, to a module 37 PCO GEARBOX. The N_target parameter is transmitted to the module 37 via a connection 38, the parameter C1 via a connection 39, the parameter Cn via a connection 40, the parameter E1 via a connection 41 and the parameter En via a connection 42.

The module 37 comprises a conventional automatic or robotized transmission control software program. It deduces from the parameters received as input, the actions to be applied to the electric motors 4a and the various units 6b included in the automatic gearbox 6 of the motor vehicle, such as, for example, the clutch or even the brakes. The actions to be applied are transmitted via the connection 10 to the automatic gearbox 6.

Moreover, in addition to the various parameters mentioned above, the generation means 36 of the module 35 creates an engine torque setpoint Cth and intended for the heat engine 4. The setpoint Cth is transmitted permanently to a module 43 PCO ENGINE, incorporated in the engine computation means 3.

The setpoint Cth is transmitted to the module 43 via a subnetwork 44 of the communication network 11, to handle the data transfers from the gearbox computation means 5 to the engine computation means 3. The setpoint Cth is transmitted permanently to the module 43 via a connection 45 of the subnetwork 44.

As for the subnetwork 30, the securing means 33 create an interchange protocol so as to secure, via a connection 46, the transfers performed via the subnetwork 44.

The module 43 is dedicated to driving the heat engine 4. It comprises a conventional engine control software program. The module 43 translates the setpoint Cth into actions on the various units (not shown) of the heat engine 4, such as, for example, the gas throttle valves or injectors (not shown). The actions to be applied are transmitted via the connection 8 to the heat engine 4b.

FIG. 3 represents an embodiment of the invention in the framework of a so-called “intersystem” operation, that is, implementing multiple modules for generating functions controlling the operation of a motor vehicle. The control functions comprise, for example, the anti-lock braking system (ABS) or even the function for controlling the path of the motor vehicle called ESP (Electronic Stability Program).

Normally, these various controls are performed by a torque intended for the engine of the motor vehicle. However, it is possible to envisage these functions controlling the torque to be applied to the wheels of the motor vehicle. The control setpoint to be applied to the wheel is then taken into account in the module 23, for the module 35, represented in FIG. 2, to incorporate them directly by translating the coordinates of the operating point.

Additional computation means 50 MC ABS-ESP are for driving the brakes 51 of the motor vehicle linked to the wheels 12 of the motor vehicle via a connection 52 and to the heat engine 4 via another connection 53. The additional computation means 50 generate actions to be applied that are transmitted via a connection 54 to the brakes 51 of the motor vehicle, taking into account information obtained from various sensors (not shown) situated on the brakes 51. This information obtained from the sensors of the brakes 51 of the motor vehicle is transmitted via a connection 55.

The data generated by the additional computation means 50 takes into account the input data delivered by the block 2 via a connection 56. Moreover, the input block 2 receives via a connection 57 information obtained from detectors (not shown) incorporated in the computation means 50, in order to record operating errors.

Furthermore, so as to directly incorporate the torque setpoints to be applied to the wheel, the additional computation means 50 transmit requests intended for the module 22. These requests (C_requests) are transmitted via a connection 59 of a communication network 58, Communication network_f.

By generating requests expressed as torque to be applied to the wheel, the anti-lock braking system and electronic stability program functions limit the processor load. In practice, they no longer have to translate their setpoints, created to be directly applied to the wheel, into engine torque setpoints, requiring the recognition of the gear engaged and the state of the torque converter in the case of a conventional automatic gearbox.

Furthermore, errors on the setpoint are limited since there is no error on the estimation of the real gear ratio as for a setpoint generated as engine torque and intended for the heat engine 4.

1-14. (canceled)

15. A device for controlling an automatic gearbox for a power-train of a motor vehicle comprising:
a first computation means for driving a heat engine of the power-train of the motor vehicle;
a second computation means for driving the heat engine and an automatic gearbox of the motor vehicle and linked to the first computation means by a communication network;
a first module for generating a torque setpoint to be applied to the wheels of the motor vehicle including a dynamic component and a static component, and interpreting a will of the driver according to input data representative of characteristics of the motor vehicle, the will of the driver, and an environment of the motor vehicle;
a second module for optimizing an operating point of the power-train as a function of the torque setpoint to be applied to the wheel delivered by the first module; and
a third module for translating coordinates of the operating point into control signals adapted to the power-train;
wherein the first computation means for driving the heat engine includes the first interpretation module and the second optimization module, and the second computation means for driving the heat engine and the automatic gearbox includes the third translation module.

16. The device as claimed in claim 15, wherein the communication network comprises means for setting up a specific data interchange protocol, verifying that data received by one computer is actually latest data updated by an other computer.

17. The device as claimed in claim 16, wherein the first computation means further comprises a software program dedicated to driving the heat engine of the automatic vehicle, for determining actions to be applied to the heat engine.

18. The device as claimed in claim 17, wherein the automatic gearbox comprises units and at least one electric motor associated with at least one electrical energy storage element, and the second computation means further comprises a software program dedicated to driving the automatic gearbox of the motor vehicle, for determining actions to be applied to the units of the automatic gearbox.

19. The device as claimed in claim 18, wherein the second optimization module is fed with the following input parameters:
a dynamic component of the torque setpoint to be applied to the wheels of the motor vehicle,
a static component of the torque setpoint applicable to the wheels of the motor vehicle,
a positive limiting setpoint of a speed gradient intended for the heat engine,
a negative limiting setpoint of the speed gradient intended for the heat engine,
the input parameters being generated by means contained in the first module.

20. The device as claimed in claim 19, wherein the second module comprises means for generating a speed setpoint for the heat engine, for correcting the dynamic component of the torque setpoint to be applied to the wheels of the motor vehicle, and generating a new dynamic component of the torque setpoint to be applied to the wheels of the motor vehicle.

21. The device as claimed in claim 20, wherein the communication network comprises means for transferring the speed setpoint for the heat engine and the dynamic component of the torque setpoint to be applied to the wheel of the motor vehicle, from the second module to the third module.

22. The device as claimed in claim 21, wherein the third module comprises means for generating a new speed setpoint for the heat engine, torque setpoints for the electric motor of the motor vehicle, current, voltage or power setpoints, for the electrical energy storage elements, and an engine torque setpoint intended for the heat engine.

23. The device as claimed in claim 22, wherein the communication network comprises means for transferring the engine torque setpoint intended for the heat engine, from the third module to the software program for driving the heat engine.

24. The device as claimed in claim 23, wherein the automatic gearbox and the heat engine of the motor vehicle are fed by a control setpoint respectively generated by the software programs for driving the automatic gearbox and the heat engine of the motor vehicle.

25. The device as claimed in claim 24, wherein the software programs for driving the automatic gearbox, the heat engine, and the electric motor of the motor vehicle are fed by data obtained respectively from integrated sensors on the automatic gearbox and on the heat engine of the motor vehicle.

26. The device as claimed in claim 25, wherein the first module is fed by wheel anti-lock and motor vehicle path control setpoints, delivered by an additional computation means.

27. A method of controlling an automatic gearbox of a power-train for a motor vehicle, comprising:
generating, in a first computation means, data for a heat engine of the power-train of the motor vehicle, and generating, in a second computation means, data for driving a heat engine and the automatic gearbox of the motor vehicle,
wherein, the first computation means generates, by interpreting a will of the driver, a torque setpoint to be applied to wheels of motor vehicle and an operating point determined as a function of the torque to be applied to the wheels of the motor vehicle is optimized, and, in the second computation means, coordinates of the operating point are translated into control signals adapted to the power-train.

28. The method as claimed in claim 27, wherein data is interchanged between the first and the second computation means via a secure communication network.
